(19) United States
(12) Patent Application Publication
(10) Pub. No.: US 2026/0066643 A1
(43) Pub. Date: Mar. 5, 2026

(54) LEAKAGE PROTECTION DEVICES, ELECTRICAL CONNECTION EQUIPMENT AND ELECTRICAL APPLIANCES

(71) Applicant: Chengli LI, Suzhou (CN)

(72) Inventors: Chengli LI, Suzhou (CN); Long Chen, Suzhou (CN)

(73) Assignee: Chengli LI, Suzhou (CN)

(21) Appl. No.: 19/033,422

(22) Filed: Jan. 21, 2025

Related U.S. Application Data
(63) Continuation-in-part of application No. 18/911,925, filed on Oct. 10, 2024.

(30) Foreign Application Priority Data
Aug. 28, 2024 (CN) 202411190317.6
Aug. 28, 2024 (CN) 202422095658.7
Jan. 17, 2025 (CN) 202510075131.4
Jan. 17, 2025 (CN) 202520111172.X

(51) Int. Cl. H02H 5/04; H02H 3/16

(52) U.S. Cl. CPC H02H 5/044; H02H 3/162

(57) ABSTRACT

A leakage protection device includes: a switch module for controlling power connection between input and output ends of current-carrying lines; a leakage detection module for detecting a leakage current signal on the current-carrying lines and generating a leakage fault signal when the leakage current signal is detected or exceeds a preset threshold; an over-temperature protection module, including first and second temperature sensors, respectively located close to first and second plug blades to detect temperatures near them, to generate over-temperature fault signals when the detected temperature exceeds a preset threshold; a driving module for receiving the leakage fault signal and driving the switch module to disconnect the power connection in response thereto. The device can disconnect the power connection quickly when the temperature of a plug blade is too high to avoid danger, and has a high over-temperature protection accuracy.

### BACKGROUND OF THE INVENTION

The invention relates to the electrical field, and in particular to a leakage protection device, an electrical connection device and an electrical appliance.

In order to improve the safety of electricity use, leakage protection devices are being used more and more widely, and their application fields and scenarios are continuing to increase. Existing leakage protection devices can provide basic leakage protection functions. When leakage is detected at the load end, the device can quickly cut off the power to the load end to protect the personal safety of the user. However, in actual use, there is often local overheating of the leakage protection device due to poor contact caused by reduced socket clamping force, line overload and other reasons. This can cause the device shell to melt and even cause fires from time to time, which brings major safety hazards and seriously endangers the safety of users'lives and property.

### SUMMARY OF THE INVENTION

Based on the above problem, a first aspect of the present invention provides a leakage protection device, which includes: a switch module, which is coupled between an input end and an output end of current-carrying lines and is configured to control a power connection between the input end and the output end, wherein the input end of the current-carrying lines is coupled to a first plug blade and a second plug blade; a leakage detection module, which is configured to detect a leakage current signal on the current-carrying lines and generate a leakage fault signal when the leakage current signal is detected or when the leakage current signal exceeds a preset threshold; an over-temperature protection module, which includes a first temperature sensor and a second temperature sensor, wherein the first temperature sensor is arranged adjacent to the first plug blade and is configured to detect a temperature near the first plug blade, and the second temperature sensor is arranged adjacent to the second plug blade and is configured to detect a temperature near the second plug blade, wherein the over-temperature protection module is configured to generate an over-temperature fault signal when the temperature detected by the first temperature sensor and/or the second temperature sensor exceeds a preset threshold; and a driving module, which is coupled to the switch module and the leakage detection module and is configured to receive the leakage fault signal and drive the switch module to disconnect the power connection in response to the leakage fault signal.

In some embodiments, the over-temperature protection module further includes: a first voltage divider element, which is coupled in series with the first temperature sensor; a second voltage divider element, which is coupled in series with the second temperature sensor; and a first comparison unit, which is coupled to the first voltage divider element and the second voltage divider element, wherein when the temperature detected by the first temperature sensor and/or the second temperature sensor exceeds the preset threshold, the first voltage divider element and/or the second voltage divider element provides an over-temperature detection signal to the first comparison unit, thereby causing the first comparison unit to generate the over-temperature fault signal.

In some embodiments, the over-temperature protection module further includes: a first isolation element, coupled between the first temperature sensor and the first comparison unit; and a second isolation element, coupled between the second temperature sensor and the first comparison unit, wherein the first isolation element and the second isolation element are configured to isolate the temperature detection signals of the first temperature sensor and the second temperature sensor.

In some embodiments, the first isolation element and the second isolation element are diodes respectively.

In some embodiments, the leakage protection module includes a leakage detection chip, and the leakage detection chip is coupled to the first comparison unit to provide a reference voltage to the first comparison unit; or the over-temperature protection module further includes a third voltage divider element and a fourth voltage divider element coupled in series, and the third voltage divider element and the fourth voltage divider element are coupled to the first comparison unit and are configured to provide a reference voltage to the first comparison unit.

In some embodiments, the over-temperature protection module further includes: a first voltage divider element, which is coupled in series with the first temperature sensor; a second voltage divider element, which is coupled in series with the second temperature sensor; a first comparison unit, which is coupled to the first voltage divider element; and a second comparison unit, which is coupled to the second voltage divider element, wherein, when the temperature detected by the first temperature sensor exceeds the preset threshold, the first voltage divider element provides an over-temperature detection signal to the first comparison unit, thereby causing the first comparison unit to generate the over-temperature fault signal; and/or when the temperature detected by the second temperature sensor exceeds the preset threshold, the second voltage divider element provides the over-temperature detection signal to the second comparison unit, thereby causing the second comparison unit to generate the over-temperature fault signal.

In some embodiments, the driving module is further coupled to the over-temperature protection module, and is further configured to receive the over-temperature fault signal, and drive the switch module to disconnect the power connection in response to the over-temperature fault signal.

In some embodiments, the driving module further includes: at least one first semiconductor element, which is coupled to the leakage detection module and configured to receive the leakage fault signal and change its switch state in response to the leakage fault signal; and at least one second semiconductor element, which is coupled to the over-temperature protection module and configured to receive the over-temperature fault signal and change its switch state in response to the over-temperature fault signal.

In some embodiments, the driving module further includes: a reset switch, which is operable to: drive the switch module to connect the power connection again after the driving module drives the switch module to disconnect the power connection in response to the leakage fault signal, and keep the power connection disconnected after the driving module drives the switch module to disconnect the power connection in response to the over-temperature fault signal.

In some embodiments, the leakage protection device further includes: an over-temperature self-test module, which is coupled to the over-temperature protection module and the driving module, and is configured to detect whether the over-temperature protection module has failed, and generate an over-temperature self-test fault signal when the over-temperature protection module has failed, and the driving module is further configured to receive the over-temperature self-test fault signal and drive the switch module to disconnect the power connection in response to the over-temperature self-test fault signal.

In some embodiments, the over-temperature self-test module includes a third comparison unit, which is coupled to the first temperature sensor and the second temperature sensor and configured to be triggered to generate the over-temperature self-test fault signal when the first temperature sensor and/or the second temperature sensor has failed.

In some embodiments, the over-temperature self-test module further includes: a first voltage regulator component, which is coupled to the first temperature sensor and the third comparison unit; a second voltage regulator component, which is coupled to the second temperature sensor and the third comparison unit, wherein the first voltage regulator component and the second voltage regulator component are configured to increase the trigger voltage of the third comparison unit.

In some embodiments, the over-temperature self-test module further includes: a third isolation element, coupled between the first temperature sensor and the third comparison unit; and a fourth isolation element, coupled between the second temperature sensor and the third comparison unit, wherein the third isolation element and the fourth isolation element are configured to isolate the temperature detection signals of the first temperature sensor and the second temperature sensor.

In some embodiments, the leakage protection device further includes: a leakage self-test module, which is coupled to the leakage detection module and the driving module, and is configured to periodically generate a simulated leakage current signal to detect whether the leakage detection module and/or the driving module has failed, and to generate a leakage self-test fault signal when the leakage detection module and/or the driving module has failed, and wherein the driving module is further configured to receive the leakage self-test fault signal and drive the switch module to disconnect the power connection in response to the leakage self-test fault signal.

The leakage protection device provided in the first aspect of the present invention includes an over-temperature protection module, and by arranging temperature sensors adjacent to the two plug blades respectively, the temperature of the two plug blades can be accurately and independently detected, thereby improving the accuracy of over-temperature protection. When the temperature of a plug blade is too high, an over-temperature fault signal can be generated, which avoids danger, eliminates potential safety hazards, and increases the safety of the leakage protection device.

A second aspect of the present invention provides a leakage protection device, which includes: a switch module, which is coupled between an input end and an output end of current-carrying lines and is configured to control a power connection between the input end and the output end; a leakage detection module, which is configured to detect a leakage current signal on the current-carrying lines and generate a leakage fault signal when the leakage current signal is detected or when the leakage current signal exceeds a preset threshold; an over-temperature protection module, which is configured to detect the temperature of a specific element and/or at a specific position and generate an over-temperature fault signal when the temperature of the specific element and/or at the specific position exceeds a preset threshold; and a driving module, which is coupled to the switch module, the driving module including: at least one first semiconductor element, which is coupled to the leakage detection module and is configured to receive the leakage fault signal and change its switch state in response to the leakage fault signal, thereby driving the switch module to disconnect the power connection; and at least one second semiconductor element, which is coupled to the over-temperature protection module and is configured to receive the over-temperature fault signal and change its switch state in response to the over-temperature fault signal, thereby driving the switch module to disconnect the power connection.

In some embodiments, the driving module further includes: a reset switch, which is operable to: drive the switch module to reconnect the power connection after the at least one first semiconductor element drives the switch module to disconnect the power connection in response to the leakage fault signal, and keep the power connection disconnected after the at least one second semiconductor element drives the switch module to disconnect the power connection in response to the over-temperature fault signal.

In some embodiments, the leakage protection device further includes: an over-temperature self-test module, which is coupled to the over-temperature protection module and the driving module, and is configured to detect whether the over-temperature protection module has failed, and generate an over-temperature self-test fault signal when the over-temperature protection module has failed, and wherein the at least one second semiconductor element is further configured to receive the over-temperature self-test fault signal and change its switch state in response to the over-temperature self-test fault signal, thereby driving the switch module to disconnect the power connection.

In some embodiments, the over-temperature protection module includes at least one temperature sensor, and the over-temperature self-test module includes a third comparison unit, which is coupled to the at least one temperature sensor and is configured to be triggered to generate the over-temperature self-test fault signal when the at least one temperature sensor has failed.

In some embodiments, the over-temperature self-test module further includes at least one voltage regulator component coupled to the at least one temperature sensor and the third comparison unit, wherein the at least one voltage regulator component is configured to increase a trigger voltage of the third comparison unit.

The leakage protection device provided in the second aspect of the present invention realizes the independence of the two functions of leakage protection and over-temperature protection by respectively providing different semiconductor elements for the leakage detection module and the over-temperature protection module to drive the switch module, thereby further increasing the safety of the leakage protection device.

The third aspect of the present invention provides a leakage protection device, which includes: a switch module, which is coupled between the input end and the output end of the current-carrying lines and is configured to control the power connection between the input end and the output end; a leakage detection module, which is configured to detect the leakage current signal on the current-carrying lines, and generate a leakage fault signal when the leakage current signal is detected or when the leakage current signal exceeds a preset threshold; an over-temperature protection module, which is configured to detect the temperature of a specific component and/or at a specific position, and generate an over-temperature fault signal when the temperature of the specific component and/or at the specific position exceeds a preset threshold; an over-temperature self-test module, which is coupled to the over-temperature protection module and is configured to detect whether the over-temperature protection module has failed and generate an over-temperature self-test fault signal when the over-temperature protection module has failed; and a driving module, which is coupled to the switch module, the leakage detection module, the over-temperature protection module and the over-temperature self-test module, and is configured to receive the leakage fault signal, the over-temperature fault signal and the over-temperature self-test fault signal, and drive the switch module to disconnect the power connection in response to one or more of the leakage fault signal, the over-temperature fault signal and the over-temperature self-test fault signal.

In some embodiments, the over-temperature protection module includes at least one temperature sensor, and the over-temperature self-test module includes a third comparison unit, which is coupled to the at least one temperature sensor and is configured to be triggered to generate the over-temperature self-test fault signal when the at least one temperature sensor has failed.

In some embodiments, the over-temperature self-test module further includes at least one voltage regulator component coupled to the at least one temperature sensor and the third comparison unit, wherein the at least one voltage regulator component is configured to increase a trigger voltage of the third comparison unit.

The leakage protection device provided in the third aspect of the present invention performs self-test on the over-temperature protection function of the device by providing an over-temperature self-test module, and cuts off the power connection when the over-temperature protection function has failed, thereby further increasing the safety of the leakage protection device.

A fourth aspect of the present invention provides an electrical connection device, which includes: a housing; and a leakage protection device according to any one of the embodiments of the first, second and third aspects, wherein the leakage protection device is accommodated in the housing.

A fifth aspect of the present invention provides an electrical appliance, which includes: an electrical load; and an electrical connection device according to any one of the embodiments of the fourth aspect, which is coupled to the electrical load and is used to supply power to the electrical load.

### BRIEF DESCRIPTION OF DRAWINGS

Preferred embodiments of the present invention are described with reference to the drawings. These drawings explain the embodiments and their operating principle, and only illustrate structures that are necessary to the understanding of the invention.

These drawings are not to scale. In the drawings, like features are designated by like reference symbols. In the block diagrams, lines between blocks represent electrical or magnetic coupling of the blocks; the absence of lines between blocks does not mean the lack of coupling.

FIG. 1 is a block diagram of a leakage protection device according to an embodiment of the present invention.

FIG. 2 is a block diagram of a leakage protection device according to another embodiment of the present invention.

FIG. 3 is a block diagram of a leakage protection device according to another embodiment of the present invention.

FIG. 4 is a circuit diagram of a leakage protection device according to an embodiment of the present invention.

FIG. 5A is a circuit diagram of an over-temperature protection module according to an embodiment of the present invention.

FIG. 5B is a circuit diagram of an over-temperature protection module and a part of a driving module according to another embodiment of the present invention.

FIG. 5C is a circuit diagram of an over-temperature protection module and a part of a driving module according to another embodiment of the present invention.

FIG. 5D is a circuit diagram of an over-temperature protection module, an over-temperature self-test module and a part of a driving module according to another embodiment of the present invention.

FIG. 5E is a circuit diagram of an over-temperature protection module, an over-temperature self-test module and a part of a driving module according to another embodiment of the present invention.

FIG. 5F is a circuit diagram of an over-temperature protection module and a part of a driving module according to another embodiment of the present invention.

FIG. 6 is a circuit diagram of a leakage protection device according to another embodiment of the present invention.

### DETAILED DESCRIPTION OF THE INVENTION

Preferred embodiments of the present invention are described below with reference to the drawings. These drawings and descriptions explain embodiments of the invention but do not limit the invention. The described embodiments are not all possible embodiments of the present invention. Other embodiments are possible without departing from the spirit and scope of the invention, and the structure and/or logic of the illustrated embodiments may be modified. Thus, it is intended that the scope of the invention is defined by the appended claims.

Before describing the embodiments, some terms used in this disclosure are defined here to help the reader better understand this disclosure.

In this disclosure, terms such as “connect”, “couple”, “link” etc. should be understood broadly, without limitation to physical connection or mechanical connection, but can include electrical connection, and can include direct or indirection connections. Terms such as “a”and “one”do not limit the quantity, and refers to “at least one”.

In the descriptions below, terms such as “including” are intended to be open-ended and mean “including without limitation”, and can include other contents. “Based on” means “at least partly based on. ” “An embodiment” means “at least one embodiment.” “Another embodiment” means “at least another embodiment,” etc. In this disclosure, the above terms do not necessarily refer to the same embodiments. Further, the various features, structures, materials or characteristics may be suitably combined in any of the one or more embodiments. Those of ordinary skill in the art may combine the various embodiments and various characteristics of the embodiments described herein when they are not contrary to each other.

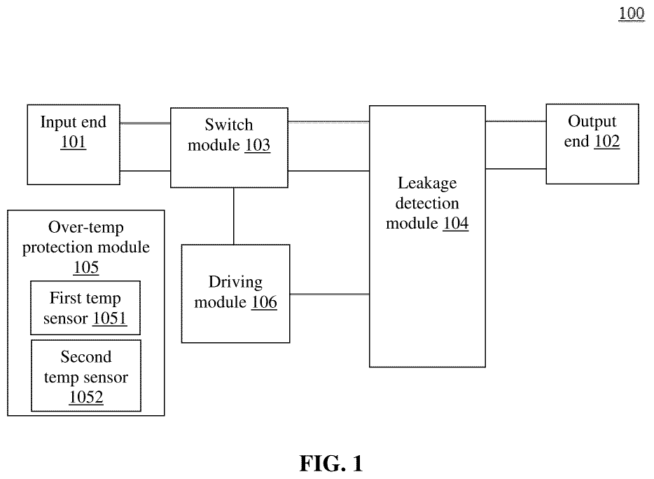

FIG. 1 shows a block diagram of a leakage protection device according to an embodiment of the present invention. As shown in FIG. 1, the leakage protection device 100 includes a switch module 103, a leakage detection module 104, an over-temperature protection module 105, and a driving module 106. The switch module 103 is coupled between the input end 101 and the output end 102 of the current-carrying lines, and controls the power connection between the input end 101 and the output end 102 of the current-carrying line. The input end 101 of the current-carrying lines is coupled to a first plug blade and a second plug blade. The current-carrying lines may include a first current-carrying line (L) for connecting to a hot line of a power grid and a second current-carrying line (N) for connecting to a neutral line of a power grid. When the first plug blade and the second plug blade are inserted into a power outlet (such as a socket), the current-carrying lines are coupled to the hot line and the neutral line of the power grid. The leakage detection module 104 is configured to detect a leakage current signal on the current-carrying lines, and to generate a leakage fault signal when a leakage current signal is detected or when the leakage current signal exceeds a preset threshold. The over-temperature protection module 105 includes a first temperature sensor 1051 and a second temperature sensor 1052. The first temperature sensor 1051 is arranged close to the first plug blade and detects the temperature near the first plug blade. The second temperature sensor 1052 is arranged close to the second plug blade and detects the temperature near the second plug blade. The first and second temperature sensors 1051 and 1052 may be thermistors, diodes and/or bimetal switches. The over-temperature protection module 105 generates an over-temperature fault signal when the temperature detected by the first temperature sensor 1051 and/or the second temperature sensor 1052 exceeds a preset threshold. The driving module 106 is coupled to the switch module 103 and the leakage detection module 104, configured to receive the leakage fault signal, and to drive the switch module 103 to disconnect the power connection in response to the leakage fault signal.

The leakage protection device 100 of this embodiment includes an over-temperature protection module 105, and by arranging temperature sensors near the two plug blades respectively, the temperature of the two plug blades can be accurately and independently detected, thereby improving the accuracy of over-temperature protection. When the temperature of a plug blade is too high, an over-temperature fault signal may be generated to avoid danger, thereby eliminating potential safety hazards and increasing the safety of the leakage protection device.

In some embodiments, the over-temperature protection module 105 further includes a first voltage divider element, a second voltage divider element and a first comparison unit. The first voltage divider element is coupled in series with the first temperature sensor 1051, and the second voltage divider element is coupled in series with the second temperature sensor 1052. The first comparison unit is coupled to the first voltage divider element and the second voltage divider element. The first and second voltage divider elements may be, for example, resistors, inductors or capacitors. The first comparison unit may be, for example, a trigger diode, a transistor, a field effect transistor and/or a comparator. When the temperature detected by the first temperature sensor 1051 and/or the second temperature sensor 1052 exceeds a preset threshold value, the first voltage divider element and/or the second voltage divider element provide an over-temperature detection signal to the first comparison unit, thereby causing the first comparison unit to generate an over-temperature fault signal.

In some embodiments, the over-temperature protection module 105 further includes a first isolation element and a second isolation element. The first isolation element is coupled between the first temperature sensor 1051 and the first comparison unit, and the second isolation unit is coupled between the second temperature sensor 1052 and the first comparison unit. The first isolation element and the second isolation element isolate the temperature detection signals of the first temperature sensor 1051 and the second temperature sensor 1052. The first and second isolation elements may be, for example, diodes. By providing an isolation element in the over-temperature protection module 105, the detection results of the two temperature sensors do not affect each other, the independence of temperature detection can be achieved, and the accuracy of over-temperature protection can be further improved.

In some embodiments, the leakage protection module 104 includes a leakage detection chip. The leakage detection chip is coupled to the first comparison unit to provide a reference voltage to the first comparison unit. Alternatively, the over-temperature protection module further includes a third voltage divider element and a fourth voltage divider element coupled in series. The third voltage divider element and the fourth voltage divider element are coupled to the first comparison unit and provide a reference voltage to the first comparison unit.

In some embodiments, the over-temperature protection module 105 includes a first voltage divider element, a second voltage divider element, a first comparison unit, and a second comparison unit. The first voltage divider element is coupled in series with the first temperature sensor 1051, and the second voltage divider element is coupled in series with the second temperature sensor 1052. The first and second comparison units may be, for example, a trigger diode, a transistor, a field effect transistor, and/or a comparator. The first comparison unit is coupled to the first voltage divider element, and the second comparison unit is coupled to the second voltage divider element. When the temperature detected by the first temperature sensor 1051 exceeds a preset threshold, the first voltage divider element provides an over-temperature detection signal to the first comparison unit, thereby causing the first comparison unit to generate an over-temperature fault signal. When the temperature detected by the second temperature sensor 1052 exceeds a preset threshold, the second voltage divider element provides an over-temperature detection signal to the second comparison unit, thereby causing the second comparison unit to generate an over-temperature fault signal. By providing two comparison units for the two temperature sensors respectively, the detection results of the two temperature sensors can be made independent of each other, the independence of temperature detection can be achieved, and the accuracy of over-temperature protection can be further improved.

In some embodiments, the driving module 106 is also coupled to the over-temperature protection module 105, to receive the over-temperature fault signal, and to drive the switch module 103 to disconnect the power connection in response to the over-temperature fault signal. By coupling the driving module 106 with the over-temperature protection module 105, the driving module 106 can cut off the power connection quickly when the temperature of the plug blades is too high, thereby eliminating safety hazard when the user is not paying attention or is not present, and further increasing the safety of the leakage protection device.

In some embodiments, the driving module 106 includes at least one first semiconductor element and at least one second semiconductor element. The at least one first semiconductor element is coupled to the leakage detection module 104, configured to receive a leakage fault signal and to change its switch state (i.e., its on/off state) in response to the leakage fault signal. The at least one second semiconductor element is coupled to the over-temperature protection module 105, configured to receive an over-temperature fault signal and to change its switch state in response to the over-temperature fault signal. By providing different semiconductor elements for the leakage detection module 104 and the over-temperature protection module 105 respectively to drive the switch module 103, the independence of the two functions of leakage protection and over-temperature protection is achieved, and the safety of the leakage protection device is further increased.

In some embodiments, the driving module 106 also includes a reset switch, which can be operated to: drive the switch module 103 to reconnect the power connection after the driving module 106 drives the switch module 103 to disconnect the power connection in response to a leakage fault signal, and keep the power connection disconnected after the driving module 106 drives the switch module 103 to disconnect the power connection in response to an over-temperature fault signal.

In some embodiments, the leakage protection device 100 further includes an over-temperature self-test module, which is coupled to the over-temperature protection module 105 and the driving module 106, configured to detect whether the over-temperature protection module 105 has failed and to generate an over-temperature self-test fault signal when the over-temperature protection module 105 has failed. The driving module 106 is configured to receive the over-temperature self-test fault signal and to drive the switch module 103 to disconnect the power connection in response to the over-temperature self-test fault signal. By providing the over-temperature self-test module, the power connection can be cut off quickly when the over-temperature protection module 105 has failed (such as the failure of the first temperature sensor 1051 and/or the second temperature sensor 1052), further increasing the safety of the leakage protection device.

In some embodiments, the over-temperature self-test module includes a third comparison unit, which is coupled to the first temperature sensor 1051 and the second temperature sensor 1052, and is triggered to generate an over-temperature self-test fault signal when a fault occurs in the first temperature sensor 1051 or the second temperature sensor 1052. The third comparison unit may be, for example, a trigger diode, a transistor, a field effect transistor and/or a comparator.

In some embodiments, the over-temperature self-test module further includes a first voltage regulator component and a second voltage regulator component. The first voltage regulator component is coupled to the first temperature sensor 1051 and the third comparison unit. The second voltage regulator component is coupled to the second temperature sensor 1052 and the third comparison unit. The first voltage regulator component and the second voltage regulator component are used to increase the trigger voltage of the third comparison unit. The first and second voltage regulator components may, for example, respectively include a combination of a resistor and a Zener diode.

In some embodiments, the over-temperature self-test module further includes a third isolation element and a fourth isolation element. The third isolation element is coupled between the first temperature sensor 1051 and the third comparison unit, and the fourth isolation element is coupled between the second temperature sensor 1052 and the third comparison unit. The third isolation element and the fourth isolation element isolate the temperature detection signals of the first temperature sensor 1051 and the second temperature sensor 1052. The third and fourth isolation elements may be diodes, for example. By providing isolation elements in the over-temperature self-test module, the detection results of the two temperature sensors do not affect each other, thereby achieving independence of temperature detection.

In some embodiments, the leakage protection device 100 further includes a leakage self-test module, which is coupled to the leakage detection module 104 and the driving module 106. The leakage self-test module periodically generates a simulated leakage current signal to detect whether the leakage detection module 104 and/or the driving module 106 has failed, and generates a self-test fault signal when the leakage detection module 104 and/or the driving module 106 has failed. The driving module 106 receives the leakage self-test fault signal, and drives the switch module 103 to disconnect the power connection in response to the leakage self-test fault signal. By providing the leakage self-test module in the leakage protection device 100, the power connection can be cut off quickly when the leakage detection module 104 and/or the driving module 106 has failed, which further increases the safety of the leakage protection device.

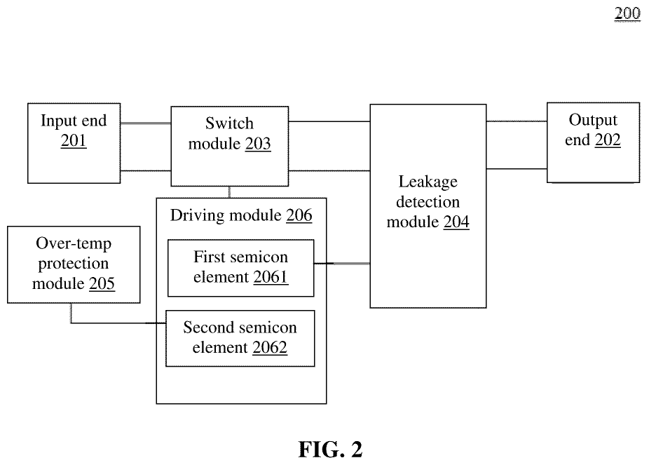

FIG. 2 shows a block diagram of a leakage protection device according to another embodiment of the present invention. As shown in FIG. 2, the leakage protection device 200 includes a switch module 203, a leakage detection module 204, an over-temperature protection module 205 and a driving module 206. The switch module 203 is coupled between the input end 201 and the output end 202 of the current-carrying lines, and controls the power connection between the input end 201 and the output end 202 of the current-carrying line. The current-carrying lines may include a first current-carrying line (L) for connecting to the hot line of the power grid and a second current-carrying line (N) for connecting to the neutral line of the power grid. The leakage detection module 204 is configured to detect a leakage current signal on the current-carrying lines, and to generate a leakage fault signal when the leakage current signal is detected or when the leakage current signal exceeds a preset threshold. The over-temperature protection module 205 may, for example, include at least one temperature sensor, which is configured to detect the temperature of a specific element and/or at a specific position, and to generate an over-temperature fault signal when the temperature of the specific element and/or a specific position exceeds a preset threshold. The driving module 206 is coupled to the switch module 203, and includes at least one first semiconductor element 2061 and at least one second semiconductor element 2062. The at least one first semiconductor element 2061 is coupled to the leakage detection module 204, and is configured to receive the leakage fault signal and to change its switch state in response to the leakage fault signal, thereby driving the switch module 203 to disconnect the power connection. The at least one second semiconductor element 2062 is coupled to the over-temperature protection module 205, and is configured to receive the over-temperature fault signal and to change its switch state in response to the over-temperature fault signal, thereby driving the switch module 203 to disconnect the power connection.

The leakage protection device 200 of this embodiment realizes the independence of the leakage protection and over-temperature protection functions by respectively providing different semiconductor elements for the leakage detection module 204 and the over-temperature protection module 205 to drive the switch module 203, thereby further increasing the safety of the leakage protection device 200.

In some embodiments, the driving module 206 further includes a reset switch, which can be operated to: drive the switch module 203 to connect the power connection again after the at least one first semiconductor element 2061 drives the switch module 203 to disconnect the power connection in response to a leakage fault signal, and keep the power connection disconnected after the at least one second semiconductor element 2062 drives the switch module 203 to disconnect the power connection in response to an over-temperature fault signal. In this way, in the event that the over-temperature protection disconnects the power connection, the user can be prevented from resetting the leakage protection device 200 by operating the reset switch, and the user needs to unplug the plug blade for inspection before using it again, which further increases the safety of the leakage protection device 200.

In some embodiments, the leakage protection device 200 further includes an over-temperature self-test module, which is coupled to the over-temperature protection module 205 and the driving module 206. The over-temperature self-test module is configured to detect whether the over-temperature protection module 205 has failed, and to generate an over-temperature self-test fault signal when the over-temperature protection module 205 has failed. The at least one second semiconductor element 2062 also receives the over-temperature self-test fault signal, and changes its switch state in response to the over-temperature self-test fault signal, thereby driving the switch module 203 to disconnect the power connection.

In some embodiments, the over-temperature protection module 205 includes at least one temperature sensor, and the over-temperature self-test module includes a third comparison unit. The third comparison unit is coupled to the at least one temperature sensor and is triggered to generate an over-temperature self-test fault signal when at least one temperature sensor has failed.

In some embodiments, the over-temperature self-test module further includes at least one voltage regulator component coupled to at least one temperature sensor and the third comparison unit. The at least one voltage regulator component is used to increase the trigger voltage of the third comparison unit.

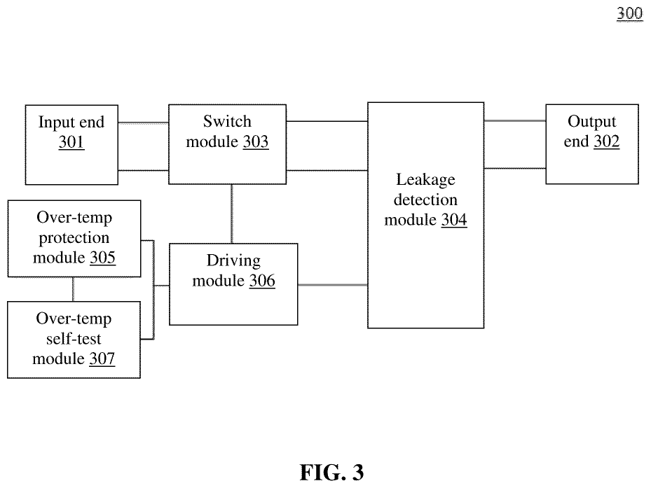

FIG. 3 shows a block diagram of a leakage protection device according to another embodiment of the present invention. As shown in FIG. 3, the leakage protection device 300 includes a switch module 303, a leakage detection module 304, an over-temperature protection module 305, a driving module 306, and an over-temperature self-test module 307. The switch module 303 is coupled between the input end 301 and the output end 302 of the current-carrying lines, and controls the power connection between the input end 301 and the output end 302 of the current-carrying line. The current-carrying lines may include a first current-carrying line (L) for connecting to the hot line of the power grid and a second current-carrying line (N) for connecting to the neutral line of the power grid. The leakage detection module 304 is configured to detect a leakage current signal on the current-carrying lines, and to generate a leakage fault signal when the leakage current signal is detected or when the leakage current signal exceeds a preset threshold. The over-temperature protection module 305 may, for example, include at least one temperature sensor, which detects the temperature of a specific component and/or at a specific position, and generates an over-temperature fault signal when the temperature of the specific component and/or at the specific position exceeds a preset threshold. The over-temperature self-test module 307 is coupled to the over-temperature protection module 305, configured to detect whether the over-temperature protection module 305 has failed, and to generate an over-temperature self-test fault signal when the over-temperature protection module 305 has failed. The driving module 306 is coupled to the switch module 303, the leakage detection module 304, the over-temperature protection module 305 and the over-temperature self-test module 307. The driving module 306 is configured to receive the leakage fault signal, the over-temperature fault signal and the over-temperature self-test fault signal, and to drive the switch module 303 to disconnect the power connection in response to one or more of the leakage fault signal, the over-temperature fault signal and the over-temperature self-test fault signal.

In some embodiments, the over-temperature protection module 305 includes at least one temperature sensor, and the over-temperature self-test module includes a third comparison unit. The third comparison unit is coupled to the at least one temperature sensor and is triggered to generate an over-temperature self-test fault signal when at least one temperature sensor has failed.

In some embodiments, the over-temperature self-test module further includes at least one voltage regulator component coupled to at least one temperature sensor and the third comparison unit. The at least one voltage regulator component is used to increase the trigger voltage of the third comparison unit.

The leakage protection device 300 of this embodiment is provided with an over-temperature self-test module to perform self-test on the over-temperature protection function of the device, and cuts off the power connection when the over-temperature protection function has failed, thereby further improving the safety of the leakage protection device 300.

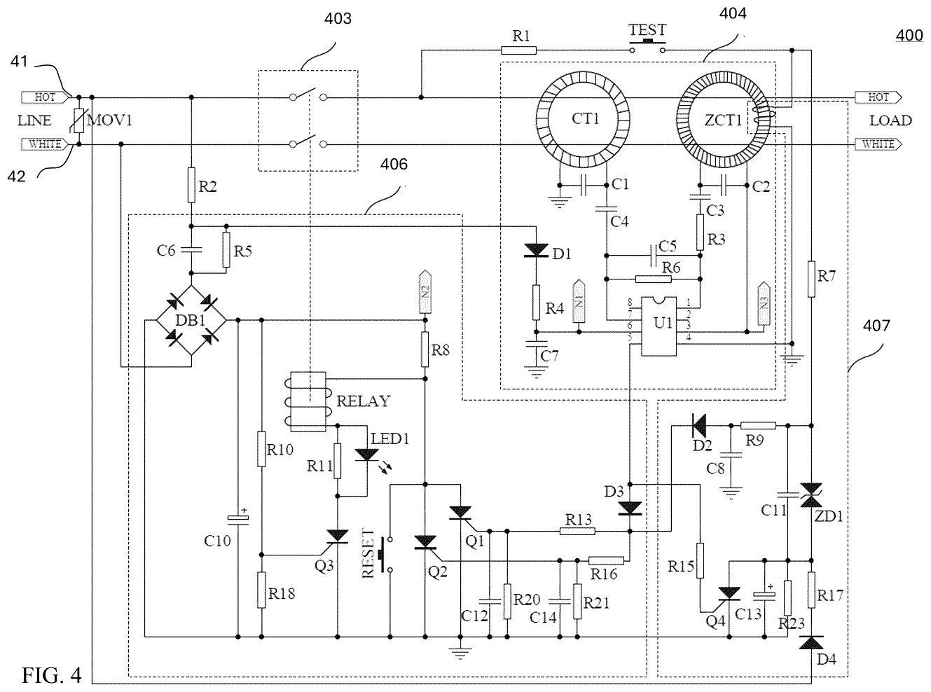

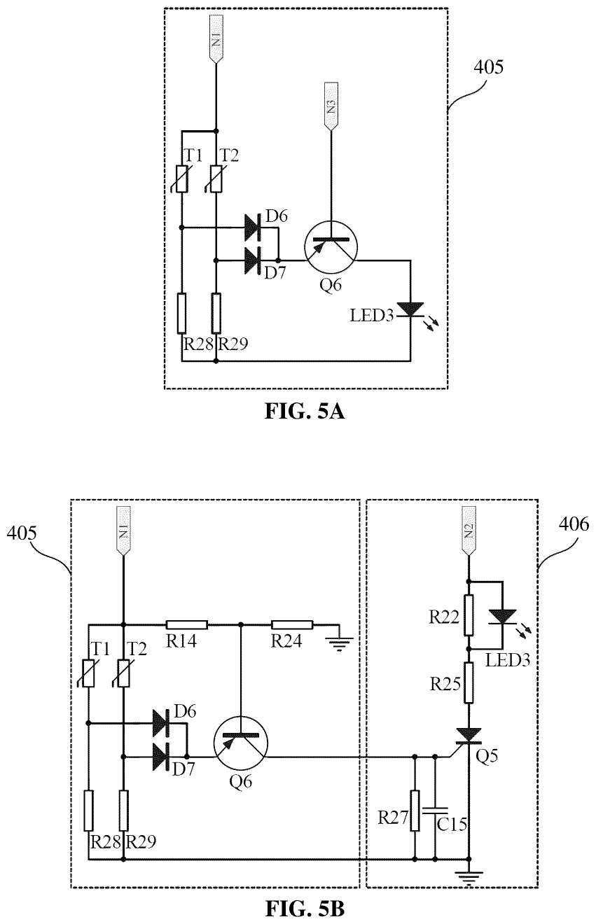

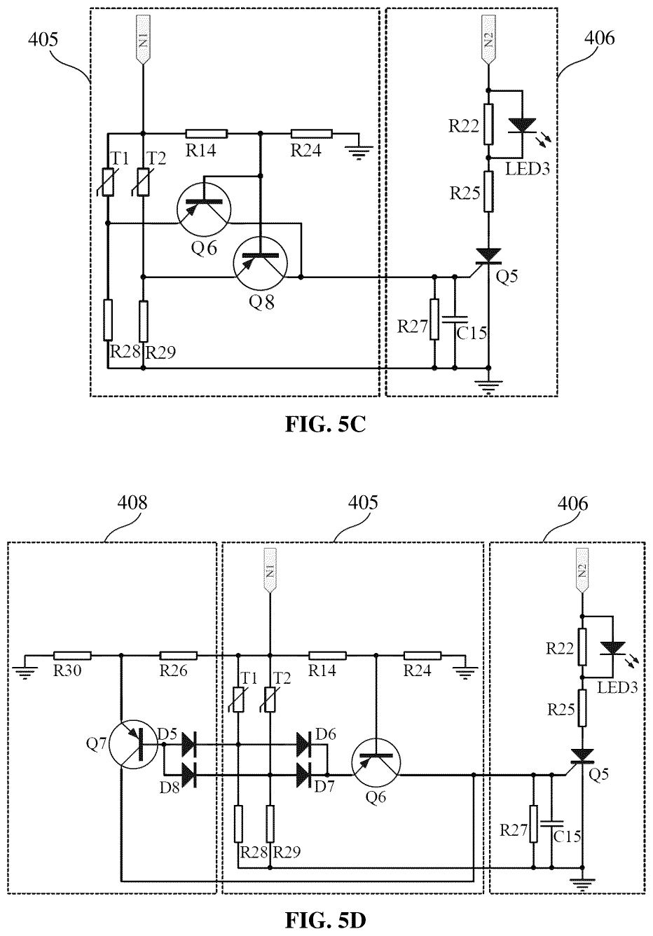

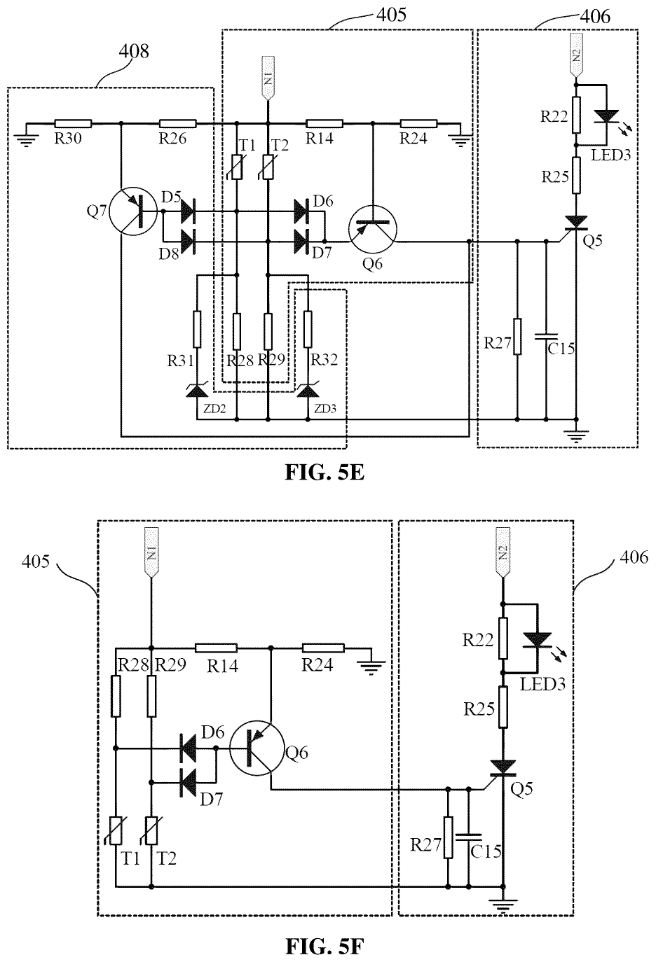

FIG. 4 shows a circuit diagram of a leakage protection device according to an embodiment of the present invention. FIG. 5A to FIG. 5F respectively show several circuit diagrams of an over-temperature protection module, an over-temperature self-test module and/or a driving module.

First, referring to FIG. 4 and FIG. 5A, the leakage protection device 400 is coupled between the input terminal LINE and the load device LOAD, and includes a switch module 403, a leakage detection module 404, an over-temperature protection module 405, a driving module 406, and a leakage self-test module 407. The input terminal LINE is coupled to the first plug blade and the second plug blade (not shown in FIG. 4). The leakage detection module 404 includes a leakage detection ring ZCT1, a leakage detection chip U1 and its peripheral circuits, and the first current-carrying line HOT 41 and the second current-carrying line WHITE 42 pass through the leakage detection ring ZCT1. The switch module 403 is used to control the power connection of the first current-carrying line 41 and the second current-carrying line 42. The over-temperature protection module 405 includes thermistors T1 (first temperature sensor) and T2 (second temperature sensor), resistors R28 (first voltage divider element) and R29 (second voltage divider element), diodes D6 (first isolation element) and D7 (second isolation element), a transistor Q6 (first comparison unit), and a light-emitting diode LED3. The thermistor T1 is arranged near the first plug blade and is used to detect the temperature near the first plug blade. The thermistor T2 is arranged near the second plug blade and is used to detect the temperature near the second plug blade. The thermistor T1 is coupled in series with the resistor R28, and the thermistor T2 is coupled in series with the resistor R29 and then coupled in parallel with the thermistor T1 and the resistor R28. The anode of the diode D6 is coupled to the thermistor T1, and the cathode is coupled to the emitter of the transistor Q6. The anode of the diode Q7 is coupled to the thermistor T2, and the cathode is also coupled to the emitter of the transistor Q6. Diodes D6 and D7 are used to isolate the temperature detection of thermistors T1 and T2. Pin 6 of the leakage detection chip U1 is coupled to a point N1 where the thermistors T1 and T2 are coupled together, and is used to provide power for them. Pin 3 of the leakage detection chip U1 is coupled to the base of the transistor Q6 to provide it with a reference voltage. The driving module 406 includes a switch driving element (such as a coil RELAY), two silicon controlled rectifiers Q1 and Q2 (first semiconductor elements) and a reset switch RESET. The leakage self-test module 407 includes a trigger diode ZD1, a capacitor C13, a silicon controlled rectifier Q4 and some peripheral components. In other embodiments, the silicon controlled rectifier Q4 may be omitted, and the silicon controlled rectifier Q1 and/or Q2 may be shared with the driving module 406, that is, the silicon controlled rectifier Q1 and/or Q2 may be coupled in parallel with the capacitor C13 to provide a discharge path for the capacitor C13 when the silicon controlled rectifiers are turned on.

Under normal circumstances, the capacitor C10 is charged through a current path HOT-R2-C6-DB1-C10. When the voltage at the upper end of the capacitor C10 rises to a level such that the voltage divided by the resistor R10 and the resistor R18 is higher than the trigger voltage of the silicon controlled rectifier Q3, the silicon controlled rectifier Q3 is turned on, and the current flows through the silicon controlled rectifier Q3 through HOT-R2-C6-DB1-R8-RELAY-LED1. The current changes in the coil RELAY, thus generating a magnetic field, driving the switch module 403 to close, thereby connecting the power connection between the input terminal LINE and the output terminal LOAD. The light-emitting diode LED1 lights up.

Meanwhile, the current powers the leakage detection chip U1 through HOT-R2-D1-R4, and generates a stable voltage at the power pin (pin 6) of the leakage detection chip U1. When a leakage current is present on the first current-carrying line 41 or the second current-carrying line 42, the leakage detection ring ZCT1 detects the leakage current signal, and the secondary end generates a corresponding induced signal. The leakage detection ring ZCT1 is coupled to the leakage detection chip U1, and the induced signal is transmitted to the leakage detection chip U1 for processing. When the value of the processed leakage current is greater than a preset threshold, pin 5 of the leakage detection chip U1 outputs a high voltage level (leakage fault signal), otherwise it outputs a low voltage level. The high voltage level at pin 5 of the leakage detection chip U1 is provided to the control electrodes of silicon controlled rectifiers Q1 and Q2 via diode D3 and resistors R13 and R16, triggering silicon controlled rectifiers Q1 and/or Q2 to turn on. At this time, the current flows into the ground via R8-Q1/Q2 and no longer flows through the coil RELAY, causing the coil RELAY to lose power, and the magnetic field disappears; as a result, the switch module 403 disconnects the power connection between the input terminal LINE and the output terminal LOAD. The user can reset the device by manually operating the reset switch RESET. Specifically, the reset switch RESET may be depressed, so that the silicon controlled rectifiers Q1 and Q2 are off, and the current flows through the silicon controlled rectifier Q3 again via HOT-R2-C6-DB1-R8-RELAY-LED1. The current changes again in the coil RELAY, generating a magnetic field, driving the switch module 403 to close, connecting the power connection between the input terminal LINE and the output terminal LOAD, and the leakage protection device 400 is reset successfully.

The leakage protection device 400 also has a leakage self-test function. The capacitor C13 is charged by a current through the current path HOT-D4-R17. As the voltage at the upper end of the capacitor C13 rises, the voltage across the trigger diode ZD1 rises accordingly. After a preset period of time, the voltage at the upper end of the capacitor C13 exceeds the trigger voltage of the trigger diode ZD1, the trigger diode ZD1 is turned on, and a current flows through the trigger diode ZD1-R7-ZCT1-ground to generate a simulated leakage current signal, and also charges the capacitor C8 through the resistor R9. In the normal working state of the leakage protection device 400, that is, the leakage detection module 404 and the driving module 406 are both working normally, the leakage detection ring ZCT1 detects the simulated leakage current signal, and its secondary end generates a corresponding induced signal and transmits it to the leakage detection chip U1. The pin 5 of the leakage detection chip U1 outputs a high voltage level, and the current charges the capacitors C12 and C14 through the resistors R13 and R16. At the same time, the current triggers the silicon controlled rectifier Q4 to turn on via R15, and the capacitor C13 is quickly discharged through the silicon controlled rectifier Q4, and the voltage at its upper end decreases rapidly. When it drops below the trigger voltage of the trigger diode ZD1, the trigger diode ZD1 is off, and the simulated leakage current signal cannot be generated, so the pin 5 of the leakage detection chip U1 stops outputting a high voltage level. Due to the short trigger time, the voltages at the upper end of the capacitors C12, C14 and C8 are low at this time, which are not enough to trigger the silicon controlled rectifier Q1 and/or Q2 to turn on, so the switch module 403 remains in a closed state.

When the leakage detection module 404 has failed and cannot detect the simulated leakage current signal, the pin 5 of the leakage detection chip U1 remains at a low voltage level, and the silicon controlled rectifier Q4 cannot be triggered to turn on.

The capacitor C13 cannot discharge through the silicon controlled rectifier Q4, and the trigger diode ZD1 is turned on for a long time, so that the voltage at the upper end of the capacitor C8 continues to rise, and the current continues to charge the capacitors C12 and C14 through the resistors R13 and R16 (i.e., a self-test fault signal is generated), so that the voltage on the upper end of the capacitors C12 and C14 rises to a certain level. If the driving module 406 works normally, the silicon controlled rectifiers Q1 and Q2 are turned on, and the current flows into the ground through R8-Q1/Q2, and no longer flows through the coil RELAY, so that the coil RELAY loses power, the magnetic field disappears, and the switch module 403 disconnects the power connection between the input terminal LINE and the output terminal LOAD.

The leakage protection device 400 also has an over-temperature protection function. At normal temperatures, the resistance of thermistors T1 and T2 is relatively high, so the voltages at the upper ends of resistors R28 and R29 are relatively low, lower than the base voltage of transistor Q6 (i.e., the reference voltage provided by pin 6 of the leakage detection chip U1), and transistor Q6 is off. When the temperature detected by thermistors T1 and/or T2 rises, their respective resistance decreases accordingly, and the voltage at the upper end of resistors R28 and/or R29 increases. When the temperature detected by thermistors T1 and/or T2 exceeds a preset threshold, the voltage at the upper end of resistors R28 and/or R29 (i.e., the over-temperature detection signal) exceeds the base voltage of transistor Q6, and transistor Q6 is turned on. A current flows through transistor Q6 via thermistors T1/T2 and diodes D6/D7, generating an over-temperature fault signal. The light-emitting diode LED3 is lit, indicating to the user that the device temperature is too high.

Reference is made to FIG. 4 and FIG. 5B. In the circuit diagram of FIG. 5B, in addition to the over-temperature protection module 405, a part of the circuit of the driving module 406 is also shown. Different from FIG. 5A, the over-temperature protection module 405 in FIG. 5B also includes resistors R14 (third voltage divider element) and R24 (fourth voltage divider element) coupled in series, with the point between them coupled to the base of the transistor Q6 (first comparison unit) to provide a base voltage to the transistor Q6. In addition, the driving module 406 also includes a silicon controlled rectifier Q5 (second semiconductor element) coupled to the transistor Q6 and its peripheral circuits. One end (N2) of the resistor R22 and the light-emitting diode LED3 coupled in parallel is coupled to the resistor R8 in FIG. 4.

At normal temperatures, the resistance of thermistors T1 and T2 is relatively high, so the voltages at the upper ends of resistors R28 and R29 are relatively low, lower than the base voltage of transistor Q6 (i.e., the reference voltage provided by the voltage divider of resistors R14 and R24), and transistor Q6 is off. When the temperature detected by thermistors T1 and/or T2 rises, their resistance decreases accordingly, and the voltage at the upper end of resistors R28 and/or R29 rises.

When the temperature detected by thermistor T1 and/or T2 exceeds the preset threshold, the voltage at the upper end of resistor R28 and/or R29 (i.e., the over-temperature detection signal) exceeds the base voltage of transistor Q6, and transistor Q6 is turned on. The current flows through transistor Q6 via thermistor T1/T2 and diode D6/D7, generating an over-temperature fault signal and triggering the silicon controlled rectifier Q5 to turn on. Most of the current flows into the ground through HOT-R2-C6-DB1-LED3-R25-Q5. The light-emitting diode LED3 is lit, indicating to the user that the device temperature is too high. Meanwhile, since most of the current no longer flows through coil RELAY, the magnetic field is weakened, insufficient to keep the switch module 403 closed, and the switch module 403 disconnects the power connection between the input terminal LINE and the output terminal LOAD.

Since the reset switch RESET is not coupled in parallel with the silicon controlled rectifier Q5, even if the user depresses the reset switch RESET, the silicon controlled rectifier Q5 cannot be turned off, and most of the current will not flow through the coil RELAY again. The user must remove the device from the power outlet, inspect the overheating condition, and insert it into the power outlet again. The leakage protection device 400 can be reset successfully after it is powered again, so that the switch module 403 can reconnect the power connection between the input terminal LINE and the output terminal LOAD.

Reference is made to FIG. 4 and FIG. 5C. Different from FIG. 5B, the over-temperature protection module 405 in FIG. 5C includes two transistors Q6 (first comparison unit) and Q8 (second comparison unit). The emitter of transistor Q6 is coupled to the thermistor T1, and the emitter of transistor Q8 is coupled to the thermistor T2. The point between resistors R14 (third voltage divider element) and R24 (fourth voltage divider element) is coupled to the bases of transistors Q6 and Q8 to provide base voltages to transistors Q6 and Q8. In FIG. 5C, diodes D6 and D7 (isolation elements) are not provided, but the independence of the temperature detection of thermistors T1 and T2 is ensured by separately providing transistors Q6 and Q8 for thermistors T1 and T2, respectively.

At normal temperatures, the resistance of thermistors T1 and T2 is high, so the voltage at the upper ends of resistors R28 and R29 are low, lower than the base voltage of transistors Q6 and Q8 (that is, the reference voltage provided by the voltage divider of resistors R14 and R24), and transistors Q6 and Q8 are off.

When the temperature detected by thermistor T1 rises, its resistance decreases accordingly, and the voltage at the upper end of resistor R28 increases. When the temperature detected by thermistor T1 exceeds the preset threshold, the upper voltage of resistor R28 (i.e., the over-temperature detection signal) exceeds the base voltage of transistor Q6, and transistor Q6 is turned on. A current flows through transistor Q6 via thermistor T1, generating an over-temperature fault signal and triggering the silicon controlled rectifier Q5 to turn on. Most of the current flows into the ground through HOT-R2-C6-DB1-LED3-R25-Q5. The light-emitting diode LED3 is lit, indicating to the user that the device temperature is too high. Meanwhile, since most of the current no longer flows through the coil RELAY, the magnetic field weakens and is insufficient to keep the switch module 403 closed. The switch module 403 disconnects the power connection between the input terminal LINE and the output terminal LOAD.

Similarly, when the temperature detected by thermistor T2 rises, its resistance decreases accordingly, and the voltage at the upper end of resistor R29 rises. When the temperature detected by thermistor T2 exceeds the preset threshold, the voltage of the upper end of resistor R29 (i.e., the over-temperature detection signal) exceeds the base voltage of transistor Q8, and transistor Q8 is turned on. A current flows through transistor Q8 via thermistor T2, generating an over-temperature fault signal and triggering the silicon controlled rectifier Q5 to turn on. Most of the current flows into the ground through HOT-R2-C6-DB1-LED3-R25-Q5. The light-emitting diode LED3 is lit, indicating to the user that the device temperature is too high. Meanwhile, since most of the current no longer flows through the coil RELAY, the magnetic field is weakened and insufficient to keep the switch module closed, and the switch module 403 disconnects the power connection between the input terminal LINE and the output terminal LOAD.

Since the reset switch RESET is not coupled in parallel with the silicon controlled rectifier Q5, even if the user depresses the reset switch RESET, the silicon controlled rectifier Q5 cannot be turned off, and the current will not flow through the coil RELAY again. The user must remove the device from the power outlet, inspect the overheating condition, and insert it into the power outlet again. The leakage protection device 400 can be reset successfully after it is powered again, so that the switch module 403 can reconnect the power connection between the input terminal LINE and the output terminal LOAD.

Reference is made to FIG. 4 and FIG. 5D. Compared with Fis. 5B, the circuit diagram of FIG. 5D also includes an over-temperature self-test module 408, which is coupled to the over-temperature protection module 405 and the driving module 406. The over-temperature self-test module 408 includes a transistor Q7 (third comparison unit), diodes D5 (third isolation element) and D8 (fourth isolation element), and voltage divider resistors R26 and R30 coupled in series. The anodes of diodes D5 and D8 are both coupled to the base of transistor Q7, and their cathodes are respectively coupled to the thermistors T1 and T2 and the anodes of diodes D6 and D7. Resistors R26 and R30 provide emitter voltage for transistor Q7 after voltage division. When thermistor T1 and/or T2 has an open circuit fault, the base of transistor Q7 is grounded through diode D5 and/or D8 and resistor R28 and/or R29, which is lower than the emitter voltage of transistor Q7 (i.e., the reference voltage provided by the voltage divider of resistors R26 and R30). The current triggers transistor Q7 to turn on through R26-Q7-D5/D8-R28/R29. Meanwhile, the current (over-temperature self-test fault signal) triggers silicon controlled rectifier Q5 to turn on through R26-Q7, and most of the current flows into the ground through HOT-R2-C6-DB1-LED3-R25-Q5. The light-emitting diode LED3 is lit, indicating to the user that the device temperature is too high. Meanwhile, since most of the current no longer flows through coil RELAY, the magnetic field is weakened, insufficient to keep the switch module 403 closed. The switch module 403 disconnects the power connection between the input terminal LINE and the output terminal LOAD, thereby realizing the over-temperature self-test function.

Reference is made to FIG. 4 and FIG. 5E. Compared with FIG. 5D, the over-temperature self-test module 408 of FIG. 5E further includes a resistor R31 and a voltage regulator diode ZD2 (first voltage regulator component) coupled in series, and a resistor R32 and a voltage regulator diode ZD3 (second voltage regulator component) coupled in series. Resistor R31 is coupled to thermistor T1, and resistor R32 is coupled to thermistor T2. Because the impedances of voltage regulator diodes ZD2 and ZD3 are higher when the currents are smaller and lower when the currents are larger, when thermistors T1 and/or T2 detect a lower temperature (such as less than 35° C.), the voltage regulator diodes ZD2 and/or ZD3 ensure that the voltage at the upper end of resistors R31 and/or R31 is higher. The emitter voltage of transistor Q7 is set at a relatively high voltage, and transistor Q7 remains off. When thermistor T1 and/or T2 has an open circuit fault, the base of transistor Q7 is grounded through diode D5 and/or D8 and resistor R28 and/or R29, which is lower than the emitter voltage of transistor Q7 (i.e., the reference voltage provided by the voltage divider of resistors R26 and R30). A current triggers transistor Q7 to turn on through R26-Q7-D5/D8-R28/R29. Meanwhile, a current (over-temperature self-test fault signal) triggers silicon controlled rectifier Q5 to turn on through R26-Q7, and most of the current flows into the ground through HOT-R2-C6-DB1-LED3-R25-Q5. The light-emitting diode LED3 is lit, indicating to the user that the device temperature is too high. Meanwhile, since most of the current no longer flows through coil RELAY, the magnetic field is weakened, insufficient to keep the switch module 403 closed. The switch module 403 disconnects the power connection between the input terminal LINE and the output terminal LOAD, thereby realizing the over-temperature self-test function. That is to say, the first voltage regulator component and the second voltage regulator component can set the voltage at the upper end of the resistors R31 and/or R32 at a relatively high level, so that the transistor Q7 can be reliably turned on when an open circuit fault occurs in T1 and/or T2, thereby improving the self-test accuracy and reliability of the self-test function of the over-temperature self-test module 408.

Reference is made to FIG. 4 and FIG. 5F. Compared with FIG. 5B, FIG. 5F swaps the emitter and base of transistor Q6, swaps thermistors T1/T2 and resistors R28/R29, and swaps the directions of diodes D6/D7.

At normal temperatures, the resistances of thermistors T1 and T2 are relatively high, so the voltages at the lower ends of resistors R28 and R29 are relatively high, higher than the emitter voltage of transistor Q6 (i.e., the voltage provided by the voltage divider of resistors R14 and R24), and transistor Q6 is off. When the temperature detected by thermistors T1 and/or T2 rises, its resistance decreases accordingly, and the voltage at the lower end of resistors R28 and/or R29 decreases.

When the temperature detected by thermistor T1 and/or T2 exceeds the preset threshold, the voltage at the lower end of resistors R28 and/or R29 (i.e., the over-temperature detection signal) is lower than the emitter voltage of transistor Q6, transistor Q6 is turned on, an over-temperature fault signal is generated, and the silicon controlled rectifier Q5 is triggered to turn on. Most of the current flows into the ground through HOT-R2-C6-DB1-LED3-R25-Q5. The light-emitting diode LED3 is lit, indicating to the user that the device temperature is too high. Meanwhile, since most of the current no longer flows through the coil RELAY, the magnetic field is weakened, insufficient to keep the switch module 403 closed, and the switch module 403 disconnects the power connection between the input terminal LINE and the output terminal LOAD.

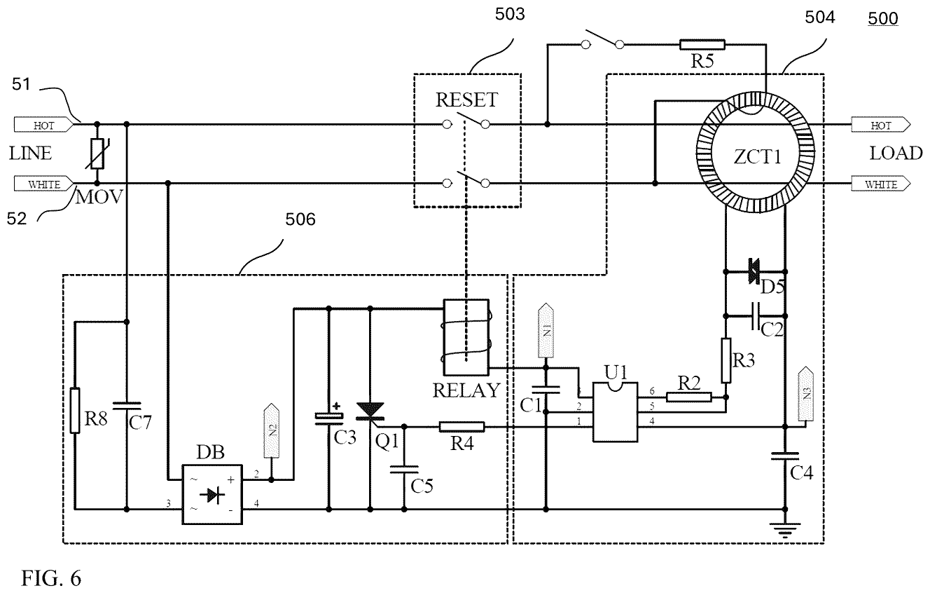

FIG. 6 shows a circuit diagram of a leakage protection device according to another embodiment of the present invention.

Referring to FIG. 6 and FIG. 5A, the leakage protection device 500 is coupled between the input terminal LINE and the load device LOAD, and includes a switch module 503, a leakage detection module 504, and a driving module 506. The leakage protection device 500 also includes the over-temperature protection module 405 shown in FIG. 5A. The input terminal LINE is coupled to the first plug blade and the second plug blade (not shown in FIG. 6). The leakage detection module 504 includes a leakage detection ring ZCT1, a leakage detection chip U1 and its peripheral circuits, and the first current-carrying line HOT 51 and the second current-carrying line WHITE 52 pass through the leakage detection ring ZCT1. The switch module 503 includes a reset switch RESET, which is used to control the power connection of the first current-carrying line 51 and the second current-carrying line 52. The thermistor T1 in the over-temperature protection module 405 is arranged near the first plug blade and used to detect the temperature near the first plug blade. The thermistor T2 is arranged near the second plug blade and used to detect the temperature near the second plug blade. Pin 3 of the leakage detection chip U1 is coupled to a point N1 where the thermistor T1 and T2 are coupled together to provide power to them. Pin 4 of the leakage detection chip U1 is coupled to the base of the transistor Q6 to provide a reference voltage to it. The driving module 506 includes a switch driving element (such as a coil RELAY) and a silicon controlled rectifier Q1 (a first semiconductor element).

Under normal circumstances, the current flows to ground through HOT-C7-DB-RELAY-U1, the coil RELAY and the leakage detection chip U1 are powered, and the power pin (pin 3) of the leakage detection chip U1 generates a stable voltage. The coil RELAY generates a magnetic field, so that the RESET switch module 503 is kept closed when it manually depressed, connecting the power connection between the input terminal LINE and the output terminal LOAD.

When there is leakage current on the first current-carrying line 51 or the second current-carrying line 52, the leakage detection ring ZCT1 detects the leakage current signal, and the secondary end generates a corresponding induced signal. The leakage detection ring ZCT1 is coupled to the leakage detection chip U1, and the induced signal is transmitted to the leakage detection chip U1 for processing. When the value of the processed leakage current is greater than a preset threshold, the pin 1 of the leakage detection chip U1 outputs a high voltage level (leakage fault signal), otherwise it outputs a low voltage level. The high voltage level of the pin 1 of the leakage detection chip U1 is provided to the control electrode of the silicon controlled rectifier Q1 via the resistor R4, triggering the silicon controlled rectifier Q1 to turn on. As a result, the current flows into the ground through HOT-C7-DB-Q1 and no longer flows through the coil RELAY, causing the coil RELAY to lose power, the magnetic field disappears, and the switch module 503 disconnects the power connection between the input terminal LINE and the output terminal LOAD. The reset switch RESET is a mechanical switch, and the user can reset the device by operating the reset switch RESET.

The leakage protection device 400 also has an over-temperature protection function. At normal temperatures, the resistances of thermistors T1 and T2 are relatively high, so the voltages at the upper ends of resistors R28 and R29 are relatively low, lower than the base voltage of transistor Q6 (i.e., the reference voltage provided by pin 4 of the leakage detection chip U1), and transistor Q6 is off. When the temperature detected by thermistors T1 and/or T2 rises, its resistance decreases accordingly, and the voltage at the upper end of resistors R28 and/or R29 increases. When the temperature detected by thermistors T1 and/or T2 exceeds the preset threshold, the voltage at the upper end of resistors R28 and/or R29 (i.e., the over-temperature detection signal) exceeds the base voltage of transistor Q6, and transistor Q6 is turned on. The current flows through transistor Q6 via thermistors T1/T2 and diodes D6/D7, and an over-temperature fault signal is generated. The light-emitting diode LED3 is lit, indicating to the user that the device temperature is too high.

Similar to the leakage protection device 400, in other embodiments, the leakage protection device 500 may include an over-temperature protection module 405 and a part of the driving module 406 as shown in FIG. 5B; or an over-temperature protection module 405 and a part of the driving module 406 as shown in FIG. 5C; or an over-temperature protection module 405, a part of the driving module 406 and an over-temperature self-test module 408 as shown in FIG. 5D; or an over-temperature protection module 405, a part of the driving module 406 and an over-temperature self-test module 408 as shown in FIG. 5E; or an over-temperature protection module 405 and a part of the driving module 406 as shown in FIG. 5F. Their over-temperature protection function, driving function and over-temperature self-test function (if any) are as described above, and will not be repeated here.

Some additional embodiments of the present invention provide an electrical power connection device, which includes a body and a leakage current detection and protection device according to any one of the above embodiments disposed inside the body.

Other additional embodiments of the present invention provide an electrical appliance, which includes an electrical load, and an electrical power connection device coupled between a power supply and the load to supply power to the load, where the electrical power connection device employs a leakage current detection and protection device according to any one of the above embodiments.

While the present invention is described above using specific examples, these examples are only illustrative and do not limit the scope of the invention. It will be apparent to those skilled in the art that various modifications, additions and deletions can be made to the leakage protection device, electrical connection equipment and electrical appliances of the present invention without departing from the spirit or scope of the invention.

1. A leakage protection device, comprising:
a switch module, coupled between an input end and an output end of current-carrying lines and configured to control a power connection between the input end and the output end, wherein the input end of the current-carrying lines is coupled to a first plug blade and a second plug blade;
a leakage detection module, configured to detect a leakage current signal on the current-carrying lines and generate a leakage fault signal when the leakage current signal is detected or when the leakage current signal exceeds a preset threshold;
an over-temperature protection module, including a first temperature sensor and a second temperature sensor, wherein the first temperature sensor is arranged adjacent to the first plug blade and configured to detect a temperature near the first plug blade, and the second temperature sensor is arranged adjacent to the second plug blade and configured to detect a temperature near the second plug blade, wherein the over-temperature protection module is configured to generate an over-temperature fault signal when the temperature detected by the first temperature sensor and/or the second temperature sensor exceeds a preset threshold; and
a driving module, coupled to the switch module and the leakage detection module, and configured to receive the leakage fault signal and drive the switch module to disconnect the power connection in response to the leakage fault signal.

2. The leakage protection device of claim 1, wherein the over-temperature protection module further includes:
a first voltage divider element, coupled in series with the first temperature sensor;
a second voltage divider element, coupled in series with the second temperature sensor; and
a first comparison unit, coupled to the first voltage divider element and the second voltage divider element,
wherein when the temperature detected by the first temperature sensor and/or the second temperature sensor exceeds the preset threshold, the first voltage divider element and/or the second voltage divider element provides an over-temperature detection signal to the first comparison unit, and wherein the first comparison unit is configured to generate the over-temperature fault signal in response to the over-temperature detection signal.

3. The leakage protection device of claim 2, wherein the over-temperature protection module further includes:
a first isolation element, coupled between the first temperature sensor and the first comparison unit; and
a second isolation element, coupled between the second temperature sensor and the first comparison unit,
wherein the first isolation element and the second isolation element are configured to isolate temperature detection signals of the first temperature sensor and the second temperature sensor.

4. The leakage protection device of claim 3, wherein the first isolation element and the second isolation element are diodes.

5. The leakage protection device of claim 2, wherein
the leakage protection module includes a leakage detection chip, coupled to the first comparison unit and configured to provide a reference voltage to the first comparison unit; or
the over-temperature protection module further includes a third voltage divider element and a fourth voltage divider element coupled in series, wherein the third voltage divider element and the fourth voltage divider element are coupled to the first comparison unit and configured to provide a reference voltage to the first comparison unit.

6. The leakage protection device of claim 1, wherein the over-temperature protection module further includes:
a first voltage divider element, coupled in series with the first temperature sensor;
a second voltage divider element, coupled in series with the second temperature sensor;
a first comparison unit, coupled to the first voltage divider element; and
a second comparison unit, coupled to the second voltage divider element,
wherein when the temperature detected by the first temperature sensor exceeds the preset threshold, the first voltage divider element provides an over-temperature detection signal to the first comparison unit, wherein the first comparison unit is configured to generate the over-temperature fault signal in response to the over-temperature detection signal; and/or when the temperature detected by the second temperature sensor exceeds the preset threshold, the second voltage divider element provides the over-temperature detection signal to the second comparison unit, wherein the second comparison unit is configured to generate the over-temperature fault signal in response to the over-temperature detection signal.

7. The leakage protection device of claim 1, wherein the driving module is further coupled to the over-temperature protection module and is further configured to receive the over-temperature fault signal and drive the switch module to disconnect the power connection in response to the over-temperature fault signal.

8. The leakage protection device of claim 7, wherein the driving module further includes:
at least one first semiconductor element, coupled to the leakage detection module and configured to receive the leakage fault signal and change its switch state in response to the leakage fault signal; and
at least one second semiconductor element, coupled to the over-temperature protection module and configured to receive the over-temperature fault signal and change its switch state in response to the over-temperature fault signal.

9. The leakage protection device of claim 7, wherein the driving module further includes:
a reset switch, operable to: drive the switch module to connect the power connection again after the driving module drives the switch module to disconnect the power connection in response to the leakage fault signal, and keep the power connection disconnected after the driving module drives the switch module to disconnect the power connection in response to the over-temperature fault signal.

10. The leakage protection device of claim 1, further comprising:
an over-temperature self-test module, coupled to the over-temperature protection module and the driving module, and configured to detect whether the over-temperature protection module has failed and to generate an over-temperature self-test fault signal when the over-temperature protection module has failed, and
wherein the driving module is further configured to receive the over-temperature self-test fault signal and to drive the switch module to disconnect the power connection in response to the over-temperature self-test fault signal.

11. The leakage protection device of claim 10, wherein the over-temperature self-test module includes a third comparison unit, coupled to the first temperature sensor and the second temperature sensor and configured to be triggered to generate the over-temperature self-test fault signal when the first temperature sensor and/or the second temperature sensor has failed.

12. The leakage protection device of claim 11, wherein the over-temperature self-test module further includes:
a first voltage regulator component, coupled to the first temperature sensor and the third comparison unit;
a second voltage regulator component, coupled to the second temperature sensor and the third comparison unit,
wherein the first voltage regulator component and the second voltage regulator component are configured to increase a trigger voltage of the third comparison unit.

13. The leakage protection device of claim 11, wherein the over-temperature self-test module further includes:
a third isolation element, coupled between the first temperature sensor and the third comparison unit; and
a fourth isolation element, coupled between the second temperature sensor and the third comparison unit,
wherein the third isolation element and the fourth isolation element are configured to isolate temperature detection signals of the first temperature sensor and the second temperature sensor.

14. The leakage protection device of claim 1, further comprising:
a leakage self-test module, coupled to the leakage detection module and the driving module, configured to periodically generate a simulated leakage current signal to detect whether the leakage detection module has failed, and to generate a leakage self-test fault signal when the leakage detection module has failed, and
wherein the driving module is further configured to receive the leakage self-test fault signal and drive the switch module to disconnect the power connection in response to the leakage self-test fault signal.

15. A leakage protection device, comprising:
a switch module, coupled between an input end and an output end of current-carrying lines and configured to control a power connection between the input end and the output end;
a leakage detection module, configured to detect a leakage current signal on the current-carrying lines and generate a leakage fault signal when the leakage current signal is detected or when the leakage current signal exceeds a preset threshold;
an over-temperature protection module, configured to detect a temperature of a specific element and/or at a specific position and generate an over-temperature fault signal when the temperature of the specific element and/or at the specific position exceeds a preset threshold; and
a driving module, coupled to the switch module, the driving module including:
at least one first semiconductor element, coupled to the leakage detection module and configured to receive the leakage fault signal and change its switch state in response to the leakage fault signal, wherein the switch module is configured to disconnect the power connection in response to the changed switch state of the at least one first semiconductor element; and
at least one second semiconductor element, coupled to the over-temperature protection module and configured to receive the over-temperature fault signal and change its switch state in response to the over-temperature fault signal, wherein the switch module is configured to disconnect the power connection in response to the changed switch state of the at least one second semiconductor element.

16. The leakage protection device of claim 15, wherein the driving module further includes:
a reset switch, operable to: drive the switch module to reconnect the power connection after the at least one first semiconductor element drives the switch module to disconnect the power connection in response to the leakage fault signal, and keep the power connection disconnected after the at least one second semiconductor element drives the switch module to disconnect the power connection in response to the over-temperature fault signal.

17. The leakage protection device of claim 15, further comprising:
an over-temperature self-test module, coupled to the over-temperature protection module and the driving module, and configured to detect whether the over-temperature protection module has failed and generate an over-temperature self-test fault signal when the over-temperature protection module has failed, and
wherein the at least one second semiconductor element is further configured to receive the over-temperature self-test fault signal and change its switch state in response to the over-temperature self-test fault signal, wherein the switch module is configured to disconnect the power connection in response to the changes switch state of the at least one second semiconductor element.

18. The leakage protection device of claim 17, wherein the over-temperature protection module includes at least one temperature sensor, and the over-temperature self-test module includes a third comparison unit, coupled to the at least one temperature sensor and configured to be triggered to generate the over-temperature self-test fault signal when the at least one temperature sensor has failed.

19. The leakage protection device of claim 18, wherein the over-temperature self-test module further includes at least one voltage regulator component coupled to the at least one temperature sensor and the third comparison unit, wherein the at least one voltage regulator component is configured to increase a trigger voltage of the third comparison unit.

20. A leakage protection device, comprising:
a switch module, coupled between an input end and an output end of current-carrying lines and configured to control the power connection between the input end and the output end;
a leakage detection module, configured to detect the leakage current signal on the current-carrying lines and generate a leakage fault signal when the leakage current signal is detected or when the leakage current signal exceeds a preset threshold;
an over-temperature protection module, configured to detect a temperature of a specific component and/or at a specific position and generate an over-temperature fault signal when the temperature of the specific component and/or at the specific position exceeds a preset threshold;
an over-temperature self-test module, coupled to the over-temperature protection module and configured to detect whether the over-temperature protection module has failed and generate an over-temperature self-test fault signal when the over-temperature protection module has failed; and
a driving module, coupled to the switch module, the leakage detection module, the over-temperature protection module and the over-temperature self-test module, and configured to receive the leakage fault signal, the over-temperature fault signal and the over-temperature self-test fault signal, and to drive the switch module to disconnect the power connection in response to one or more of the leakage fault signal, the over-temperature fault signal and the over-temperature self-test fault signal.

21. The leakage protection device of claim 20, wherein the over-temperature protection module includes at least one temperature sensor, and the over-temperature self-test module includes a third comparison unit coupled to the at least one temperature sensor and configured to be triggered to generate the over-temperature self-test fault signal when the at least one temperature sensor has failed.

22. The leakage protection device of claim 21, wherein the over-temperature self-test module further includes at least one voltage regulator component coupled to the at least one temperature sensor and the third comparison unit, wherein the at least one voltage regulator component is configured to increase a trigger voltage of the third comparison unit.

23. An electrical connection device, comprising:
a housing; and
the leakage protection device of claim 1 disposed in the housing.

24. An electrical appliance, comprising:
an electrical load; and
the electrical connection device of claim 23, coupled to the electrical load and configured to supply power to the electrical load.

25. An electrical connection device, comprising:
a housing; and
the leakage protection device of claim 15 disposed in the housing.

26. An electrical appliance, comprising:
an electrical load; and
the electrical connection device of claim 25, coupled to the electrical load and configured to supply power to the electrical load.

27. An electrical connection device, comprising:
a housing; and
the leakage protection device of claim 20 disposed in the housing.

28. An electrical appliance, comprising:
an electrical load; and
the electrical connection device of claim 27, coupled to the electrical load and configured to supply power to the electrical load.
